(19) United States
(12) Patent Application Publication
(10) Pub. No.: US 2003/0167932 A1
(43) Pub. Date: Sep. 11, 2003

(54) Stackable and configurable colander apparatus

(76) Inventor: Chia-Lung Chen, Hinsdale, IL (US)

Correspondence Address: Welsh & Katz, Ltd., John R. Garrett, 22nd Floor, 120 South Riverside Plaza, Chicago, IL, 60606, US

(21) Appl. No.: 10/094,230

(22) Filed: Mar. 8, 2002

(51) Int. Cl. A47J 37/12

(52) U.S. Cl. 99/413

(57) ABSTRACT

A cooking or heating apparatus has a base element having a bottom and at least one sidewall extending upwardly from the bottom. A support element is located substantially above the bottom of the base element, and a spacer element is located adjacent to the support element. In particular, the stackable and configurable colander apparatus has a pot having a bottom and at least one sidewall extending upward from the bottom, a plurality of item supports located substantially above the bottom of the pot, each of the item supports having a plurality of apertures, and a plurality of spacer walls located substantially above the bottom of the pot. A respective item support of the plurality of item supports and a respective spacer wall of the plurality of spacer walls forms a respective colander. The item supports and the spacer walls are stackable and form a plurality of stack configuration of item supports and spacer walls. A respective colander holds at least one item for cooking or heating, and the pot element contains a medium for transferring heat to the item.

### FIELD OF THE INVENTION

The field of the invention relates to cooking or heating devices, and in particular, to devices that process or cook food using steam or smoke.

### BACKGROUND

The use of steam, smoke, etc., is well known for cooking food items. A steamer assembly, for example, typically includes a steamer insert, such as a colander. The steamer insert has a perforated base and a peripheral portion that extends outwardly and/or upwardly from the base. The steamer insert is dimensioned so that it is received into a cooking pan or pot, such that the perforated based is spaced above a bottom of the cooking pan or pot. Typically peripheral portion of the steamer insert rests upon a rim of the cooking pan or pot.

A traditional colander for such applications typically has a fixed height cylindrical sidewall and a perforated bottom. The cylindrical sidewall may also be perforated. During the cooking process, food is placed in the colander to allow steam or smoke to pass through the food items that are placed in the colander. It is known that different food items require different cooking times and temperatures, which translates into the cooking items being placed at different heights above, for example, water in the cooking pot which produces the steam. With fixed height cylinder sidewalls of known colanders it may be difficult to accommodate food that requires different heights above the steam producing medium in the cooking pot.

For example, a four-inch height colander is used to hold a plate of salmon fish for steaming. However, the same four-inch height colander would not be tall enough to hold a whole chicken for a smoking process. Furthermore, if the colander with a sidewall having a larger height is utilized, then it is difficult to remove a plate of salmon fish from the bottom of such a deep colander. This is especially true when the colander is hot from the steam.

The use of steam in cooking food items provides several benefits over other cooking methods, such as boiling, frying, etc., because no fat is required in the process. Another type of known steamer or colander is designed for use in conventional saucepans having the capacity of about two quarts or greater. To use such an insert, the saucepan is first filled with an appropriate amount of water, and then the insert is placed within the saucepan. The bottom surface of the insert is maintained above the level of water in the saucepan. In some configurations, the steamer has an outward upper lip that engages the side of the saucepan to support the insert above the level of the water. In other configurations, the steamer insert has legs extending from its bottom surface that supports the steamer above the level of the water.

Although known types of colanders that are used in steamers, for example, are useful for certain applications, they have major disadvantages in that they cannot be used for simultaneously cooking different types of food items. Thus, there exists the need for an improved colander apparatus for use in cooking food items.

One embodiment is a cooking or heating apparatus that has a base element having a bottom and at least one sidewall extending upwardly from the bottom. A support element is located substantially above the bottom of the base element, and a spacer element is located adjacent to the support element.

In another embodiment, a stackable and configurable colander apparatus has a pot having a bottom and at least one sidewall extending upward from the bottom, a plurality of supports located substantially above the bottom of the pot, each of the supports having a plurality of apertures, and a plurality of spacer walls located substantially above the bottom of the pot. A respective support of the plurality of supports and a respective spacer wall of the plurality of spacer walls forms a respective colander. The supports and the spacer walls are stackable and form a plurality of stack configurations of supports and spacer walls. A respective colander holds at least one item for cooking or heating, and the pot element contains a medium for cooking or heating the item (such as food, medical/surgical utensils, tools, etc.).

### BRIEF DESCRIPTION OF THE DRAWINGS

The features of the present invention, which are believed to be novel, are set forth with particularity in the appended claims. The embodiments of the invention may best be understood by a reference to the following descriptions taken in conjunction with the accompanying drawings, in the several figures of which like reference numerals identified like elements, and in which:

FIGS. 1 and 2 depict known colander cooking devices.

FIGS. 3-8 are perspective views depicting various embodiments of the colander of the present invention.

FIGS. 9 and 10 depict one embodiment of assembled components of a colander according to the present invention.

FIGS. 11-15 are cross sectional views depicting various further embodiments of a colander cooking or heating system according to the present invention.

FIGS. 16-20 depict various embodiments of the colander cooking or heating system of the present invention, depicting the stackability of the various components.

FIGS. 21 and 22 depict yet another embodiment of the present invention showing a plurality of colander cooking or heating devices.

FIGS. 23 and 24 depict another embodiment of the present invention wherein the sidewall of the colander or heating has an insulated portion.

FIGS. 25 and 26 depict another embodiment of the present invention wherein a cover assembly is formed for use on a plate.

FIGS. 27 and 28 depict another embodiment of the present invention wherein the depth of a pot is effected by a sidewall and a cover.

### DETAILED DESCRIPTION

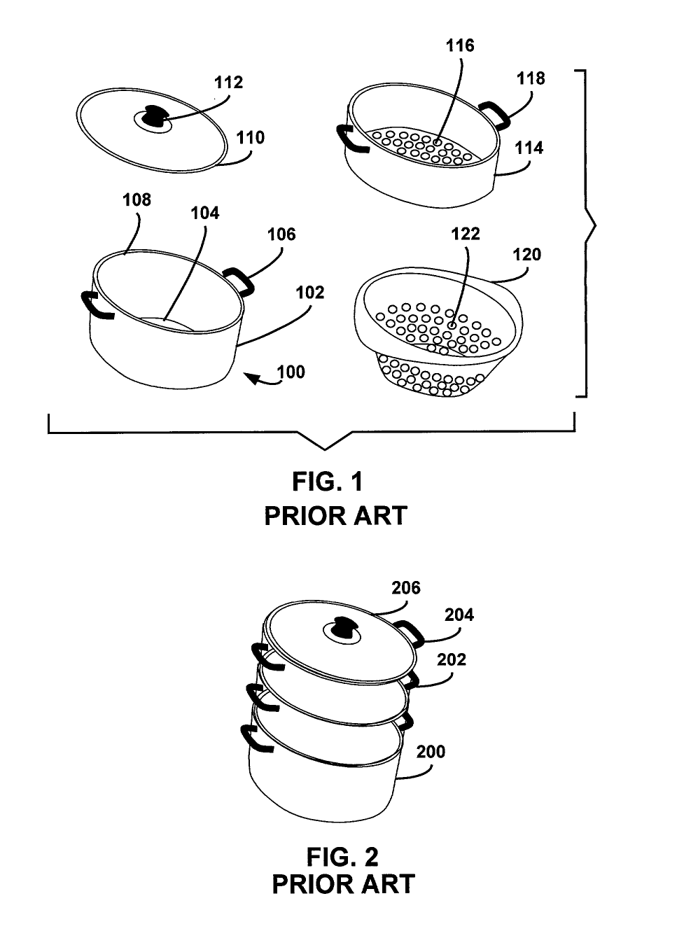

FIGS. 1 and 2 depict known colander cooking systems. In FIG. 1 a colander cooking system 100 has a pot or pan 102 having a bottom 104 attached to which is an upright cylindrical sidewall 108, which has a constant height. Typically handles 106 are attached to the sidewall 108. A cover 110 has a handle 112 and fits onto the pot 102. Colanders such as colander 114 or colander 120 may be used with the pot 102. The colanders 114, 120 have apertures 116, 122 respectively in a bottom area thereof. Handles, such as handles 118 on colander 114 may also be provided. As is known in the colanders 118, 120 are supported by a rim of the sidewall 108 of the pot 102 and may or may not be covered the cover 110.

The apertures 116, for example, in the colander 114 allow steam or smoke to immerse the food items that are support thereon during a cooking process. A plurality of colanders, such as 202 and 204 in FIG. 2 may be stacked on the pot 200. A cover 206 may be used and placed on the uppermost colander 204. Numerous types of colanders are known, and take various forms and are also referred to as sieves, strainers, etc.

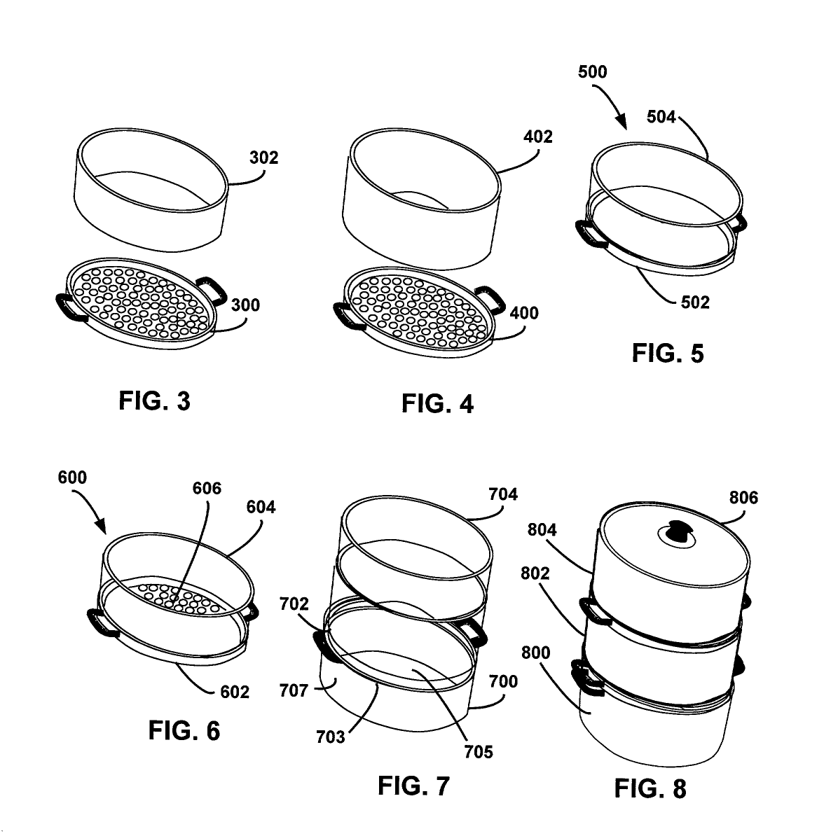

FIGS. 3-8 depict further embodiments. In FIG. 3, a colander is formed by a support element 300 and a spacer element 302. The spacer element 302 has a predetermined fixed height. However, in FIG. 4, a spacer element 402 has a different predetermined fixed height and fits on a support element 400. The assembled colander 500 is depicted in FIG. 5 wherein a spacer element 504 is positioned on a support element 502.

In another embodiment, as depicted in FIG. 6, a colander 600 has a spacer element 604, which also has apertures 606 therein. The spacer element 604 is positioned on the support element 602. As depicted in FIG. 7, a pot 700 supports a support element 702 on an upper rim thereof 703. On the support element 702 are placed one or more spacer elements 704. FIG. 8 depicts an assembled cooking apparatus, which has a pot 800, a first colander 802 (a colander being formed by a support element and a spacer element), a second colander 804 and a cover 806. The colanders 802 and 804 may have identical fixed height sidewalls or may have sidewalls having different predetermined height(s).

Referring back to FIG. 7, it is to be understood that in general the pot 700 is a base element that can take on a variety of configurations. Typically, the pot 700 has a bottom 705 and at least one sidewall 707 that extends upwardly from the bottom 705. The rim 703 of the pot 700 is on an upper edge of the sidewall 707 opposed from the bottom 705. In other words, the sidewall 707 of the base element 700 has a lower region attached to the bottom 703 of the base element 700 and an upper region opposed from the lower region. The support element 702 is thereby supported by the upper region, or rim 7037, of the sidewall 7075 of the base element 700. FIG. 8 depicts the use of two colanders 802 and 804. Each of the colanders 802 and 804 is constructed from a support element (such as support element 702 in FIG. 7), and a sidewall (such as sidewall 705 in FIG. 7). However, it is to be understood that the invention is not limited to the use of only two colanders, and three or more may be utilized depending upon the demands of the cooking process. Furthermore, it is to be understood that the support elements and spacer elements may be alternately stacked on the pot, or may be stacked in various combinations, such as two or more spacer elements being stacked on one another and then placed upon a single support element.

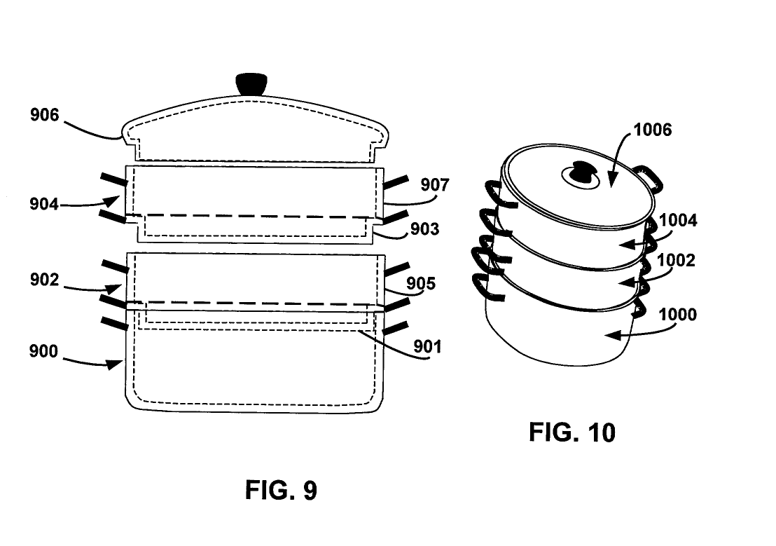

FIG. 9 is a cross sectional view depicting the use of two colanders 902, 904 formed respectively by support elements 901, 905 and spacers 903, 907. In this embodiment each of the support elements and spacers is equipped with handles. The colanders 902 and 904 are stacked on a base element or pot 900, and a cover may be utilized, such as cover 906. FIG. 10 is a perspective view showing the assembled cooking system having a pot 1000, colanders 1002, 1004, and a cover 1006. Colanders 1002 and 1004 correspond, respectively, to colanders 902 and 904 in FIG. 9.

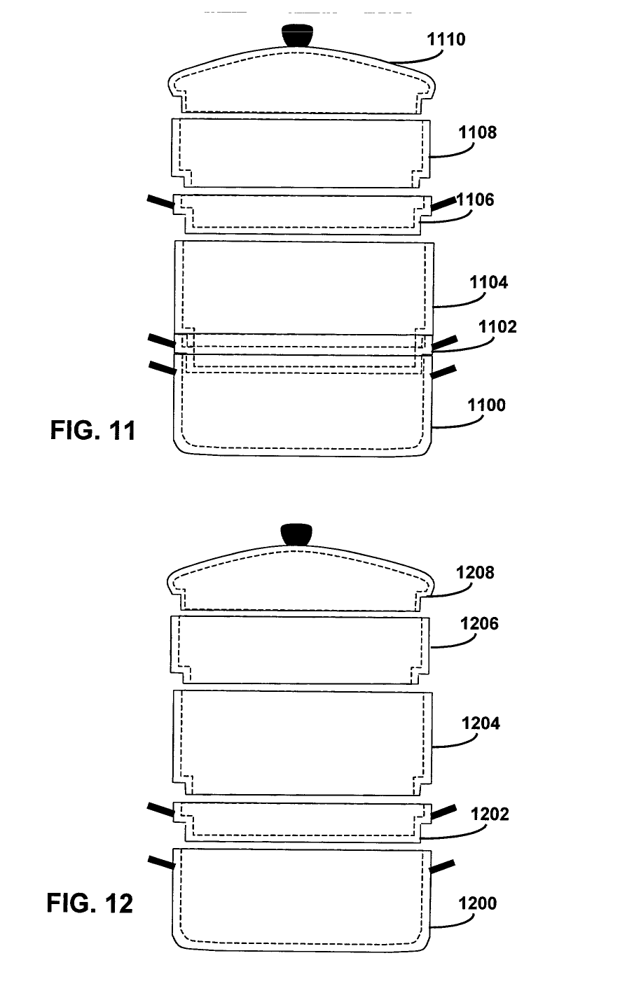

FIGS. 11 and 12 depict other possible embodiments. In FIG. 11, a pot 1100 has placed upon it a support element 1102 on which is placed a spacer element 1104 having a predetermined fixed height. On the spacer element 1104 is placed another colander 1106 with a spacer element 1108 having a different fixed height. Finally, a cover may be used such as cover 1110.

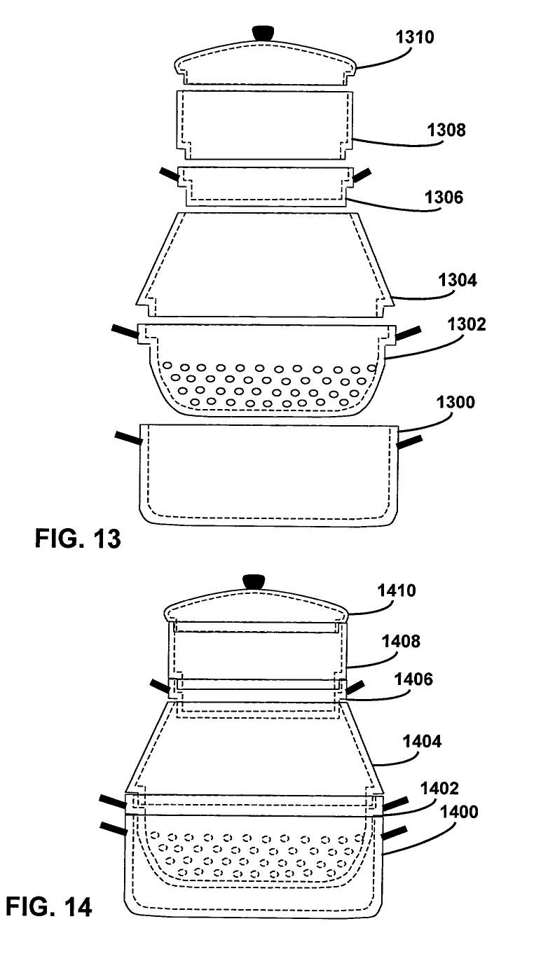

FIG. 12 depicts the use of a base element or pot 1200 on which is placed a support element 1202. In order to establish a proper height, two spacer elements 1204 and 1206 are placed on the support element 1202 as depicted. Again, a cover may be utilized such as cover 1208. Reconfiguration of the support elements and spacer elements of the novel cooking system may have different configurations. It is not necessary, for example, that the system has a circular configuration but may have other types of geometries, such as elliptical, square, etc. Furthermore, it is also envisioned that embodiments may have spacer elements, which have slopping sidewalls to allow different diameter components. Such a system is depicted in FIG. 13. In this embodiment, a pot or base elements 1300 has placed on it a colander or support element 1300 on which is placed a spacer element 1304. It is to be noted that the spacer element 1304 has a larger diameter at a lower end 1305 than at an upper end 1307 thereof. On the upper end 1307 is placed a second support element 1306 on which is placed another spacer element 1308. It is to be noted that the diameter (assuming that these are circular components) is smaller for the support element 1306 and spacer element 1308 than for the support element 1302 and spacer element 1304. The spacer element 1304 forms a transition between the two diameters as depicted. It is also noted that the spacer element 1302 may be constructed at various geometry such as the “all type configuration” as shown in FIG. 13 as opposed to the “flat” support element such as support element 1306. FIG. 14 shows an embodiment wherein the components are assembled. In this view, in FIG. 14, the base element 1400 supports the first support element 1402 on which is located the spacer element 1404 which supports the second support element 1406 and spacer element 1408. Also depicted on the spacer element 1408 is a cover 1410.

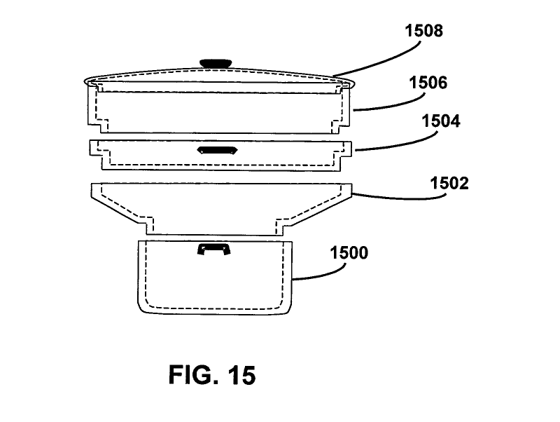

FIG. 15 depicts yet a further embodiment, wherein a pot 1500 supports a spacer element 1502 and has a first diameter (assuming that the component is circular) on a first end 1501 of the support element 1502 and a second larger diameter 1505, an upper end 1503 of the support element 1502. A support element 1504 is then placed on the upper end 1503 of the spacer element 1502 and another spacer element 1506 is placed on the support element 1504. A cover may be utilized such as cover 1508.

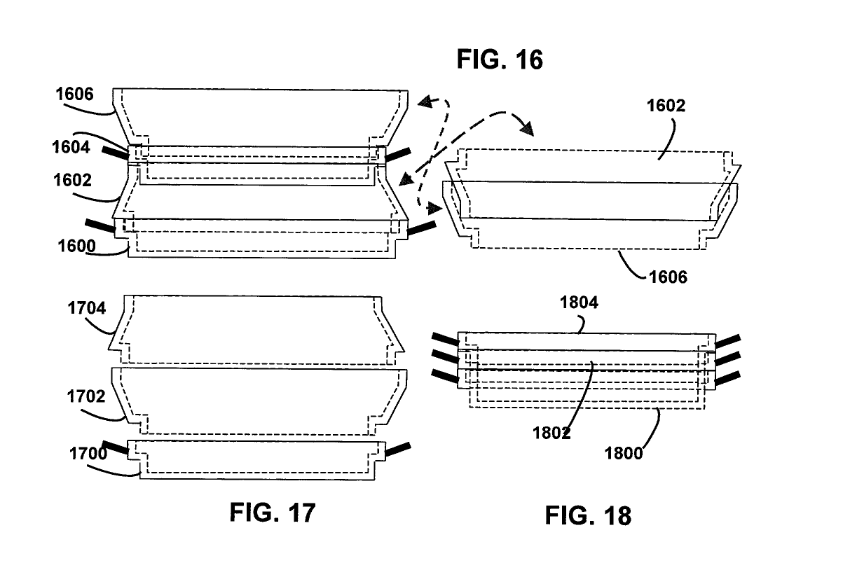

FIGS. 16, 17, and 18 depict the stackability feature of an embodiment. FIG. 16 shows at a left-hand portion the support element 1600 having thereon a spacer element 1602 on which is placed another second support element 1604 and a second spacer element 1606. All of these elements have different diameters or cross-sectional configurations as are depicted in FIG. 16. On the right-hand portion of FIG. 16 is shown how the two spacer elements 1602 and 1606 are stacked for storage. It is a feature that in the stacked configuration, as depicted in the right-hand portion of FIG. 16, the height is reduced as compared to the height of the assembled portion for cooking, as depicted in the left-hand portion of FIG. 16. FIG. 17 shows another use of the support element 1700 with two spacer elements 1702 and 1704 that have different diameters or other configurations on opposed ends thereof. Also in FIG. 18, it is depicted that the support elements, such as support elements 1800, 1802, and 1804, are also configured to be stackable in order to save space when the unit is stored away.

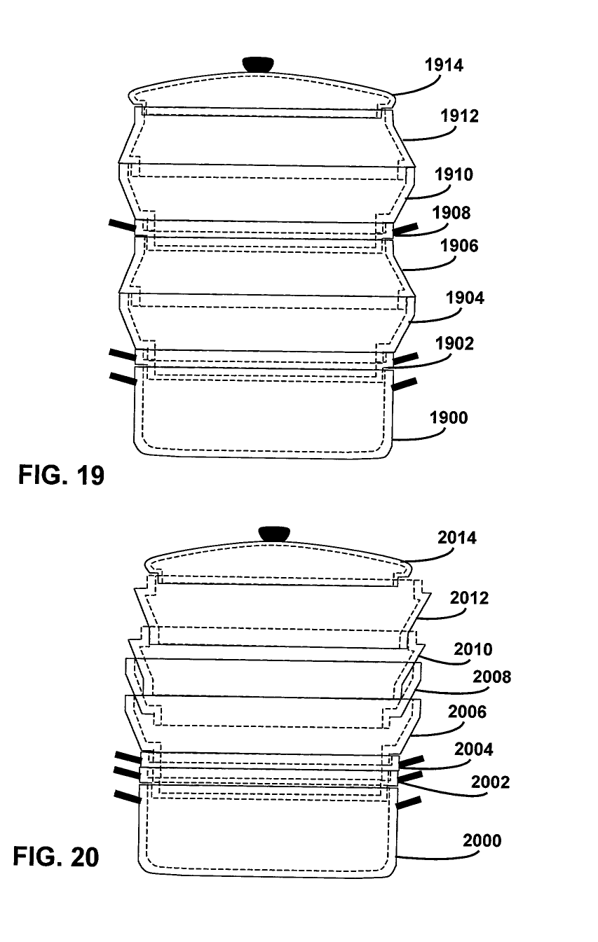

Another possible embodiment is depicted in FIG. 19 in a form assembled for cooking, and in FIG. 20 in a form for storage. In FIG. 19, a base element or pot 1900 supports a support element 1902, which in turn supports first and second spacer elements 1904 and 1906. On the spacer element 1906 is a second support element 1908, which again supports third and fourth spacer elements 1910 and 1912. A cover 1914 may be utilized on the upper most or fourth spacer element 1912. It is to be noted that in this configuration, the cover 1914 sits on the pot 1900. However, the slopping sidewalls of the support elements 1904, 1906, 1910, and 1912 allow them to be stacked for more efficient storage.

FIG. 20 shows the FIG. 19 assembly in the stacked for storage configuration. Here the pot 2002 supports the first and second support elements 2002 and 2004. Thereon is placed the four spacer elements 2006, 2008, 2010, and 2012. Finally, the cover 2014 may be placed on the upper spacer element 2012.

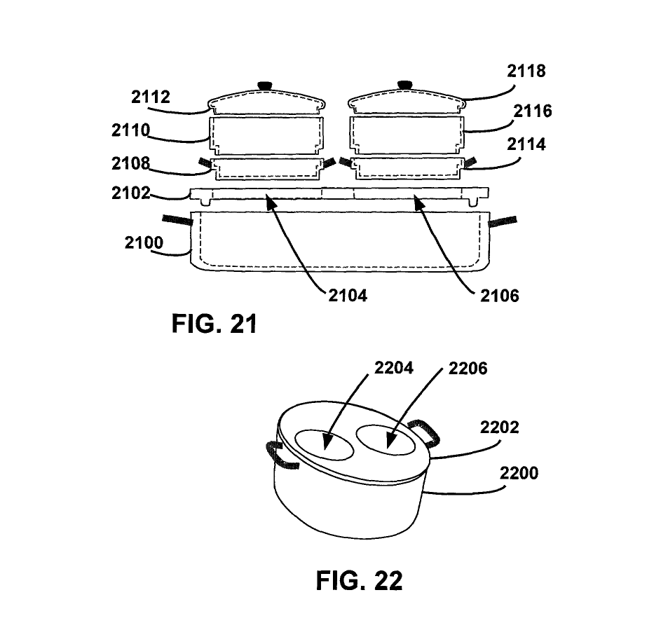

Various other embodiments and combinations of elements of the present invention may be used for forming configurable and stackable cooking or heating systems. One such system is depicted in FIG. 21 where a base element 2100 has a top portion 2102. The top portion 2102 has apertures 2104 and 2106. A colander formed by support element 2108 and spacer element 2110 may be placed, for example, in the aperture 2104. Another colander formed by support element 2114 and spacer element 2116 may be placed in the other aperture 2106. Covers may be used respectively such as covers 2112 and 2118. In the cooking or heating process, different items (such as food or other items to be heated) may be placed on the support elements 2108 and 2114, and water (or other suitable medium), for example, may be placed in the pot 2100 to produce steam that flows through apertures 2104 and 2106. The steam passes through the apertures in the support elements 2108 and 2114 for cooking respective food items thereon.

FIG. 22 is a perspective view showing a pot 2200 with a top portion 2202 having apertures 2204 and 2206. It is to be understood, of course, that configurations other than circular may be utilized for the pot 2200 and apertures 2204 and 2206. The principles of the present invention are not limited to the geometrical shapes of the elements, nor to the fitting together of the components as discussed above.

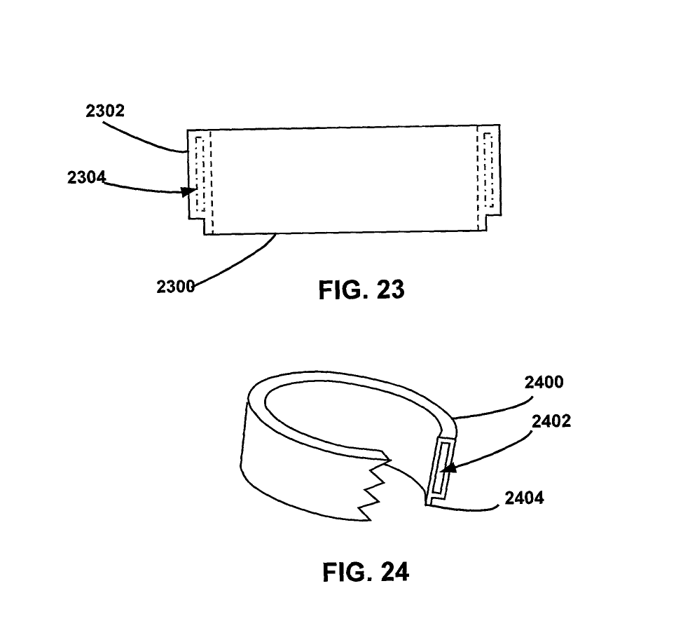

For more efficient cooking, the spacer element, such as spacer element 2300, in FIG. 23 may have sidewall 2302 that is constructed such that there is an insulating portion 2304 therein. This insulating portion 2304 may be an area that contains a vacuum or other heat insulating material. FIG. 24 is a perspective view depicting the spacer element 2400 having a insulation area 2402 and a lower edge 2404. The lower edge 2404, for example, would be used to fit onto another spacer element, a support element, or directly on the top edge of a base element.

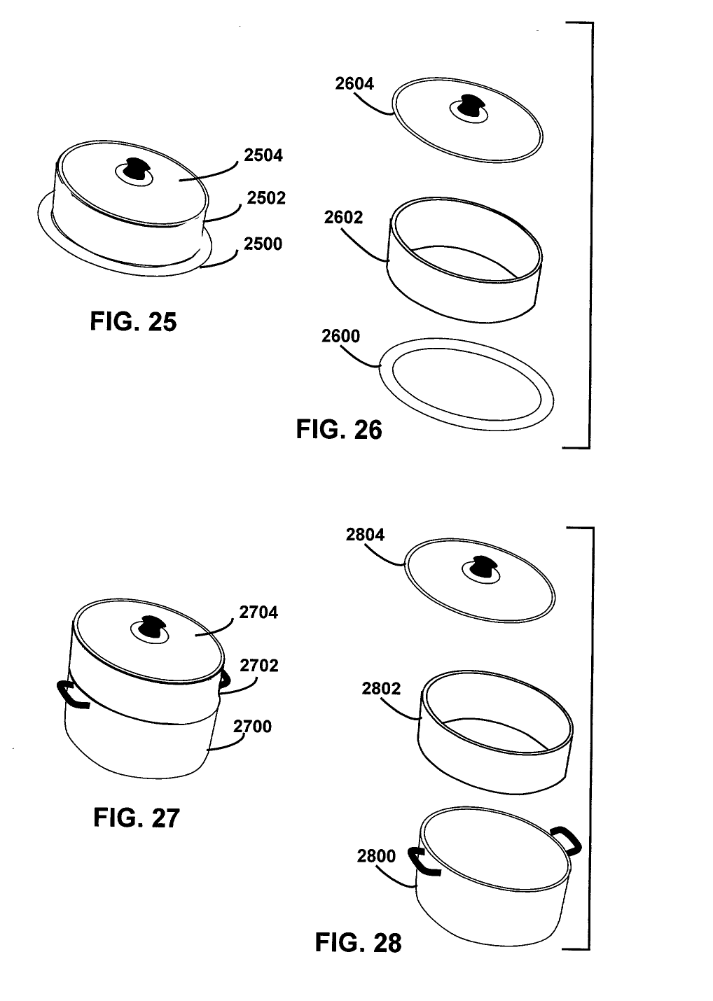

In yet a further embodiment a cover assembly for a plate 2500 (see FIG. 25) is formed by a spacer element 2502, as described above, and a cover 2504. An exploded view is depicted in FIG. 26, showing a plate 2600, a spacer element or sidewall 2602, and a cover 2604. The spacer element may also be used to extend the depth of a pot 2700 as shown in FIG. 27. The depth of pot 2700 is extended by the use of spacer element or sidewall 2702. A cover 2704 may be placed on the sidewall 2702. An exploded view is depicted in FIG. 28, showing a pot 2800, a sidewall 2802, and a cover 2804.

The present invention may be useable for a variety of purposes that are unrelated to the field of cooking. For example, the apparatus of the present invention may be used in the medical field for sterilizing surgical instruments. Furthermore, the novel apparatus may be used for cleaning items by generating gasses that are appropriate to clean the items that are supported above a medium used to produce the gasses. In these various embodiments, the base element, for example, contains the medium for transferring heat to the items that are supported on the support element, for example. Cooking, sterilizing, and heating are just some of the fields in which the present invention is useable.

Thus, the present invention overcomes the drawbacks of known colanders and cooking systems and provides a colander structure which can be placed at various heights above a cooking medium, and which can be combined with other colanders having the same or different heights. Although the support element and the spacer element together provide the colander function, the support element and the spacer element may also be used as individual functional parts. For example, the spacer may be used to extend a pot sidewall or as a cover extension. That is, a pot, spacer element, and a cover, in one example, may form one cooking configuration, and a pot and a support element may form another cooking configuration, in another example. Furthermore, the present invention provides a function of compact stacking, which reduces storage requirement for the cooking system of the present invention.

The invention is not limited to the particular details of the apparatus depicted, and other modifications and applications are contemplated. Certain other changes may be made in the above-described apparatus without departing from the true spirit and scope of the invention herein involved. For example, the components of the invention (for example, the base element, the support elements, and the spacer elements) may have various shapes and configurations, as well as being made of a variety of different materials. It is intended, therefore, that the subject matter in the above depiction shall be interpreted as illustrative and not illuminating sense.

What is claimed is:

1. An apparatus, comprising:
a base element having a bottom and at least one sidewall extending upwardly from the bottom;
a support element located substantially above the bottom of the base element; and a spacer element located adjacent to the support element.

2. The apparatus according to claim 1, wherein the sidewall of the base element has a lower region attached to the bottom of the base element and an upper region opposed from the lower region, wherein the support element is supported by the upper region of the at least one sidewall of the base element, and wherein the spacer element is located above the support element.

3. The apparatus according to claim 1, wherein the apparatus further comprises a cover that is supported by the spacer element.

4. The apparatus according to claim 1, wherein the sidewall of the base element has a lower region attached to the bottom of the base element and an upper region opposed from the lower region, wherein the spacer element is supported by the upper region of the at least one sidewall of the base element, and wherein the support element is located above the spacer element.

5. The apparatus according to claim 1, wherein the support element has a plurality of apertures.

6. An apparatus, comprising:
a base element having a bottom and at least one sidewall extending upwardly from the bottom;
a plurality of support elements located substantially above the bottom of the base element; and
a plurality of spacer elements located substantially above the bottom of the base element.

7. The apparatus according to claim 6, wherein the sidewall of the base element has a lower region attached to the bottom of the base element and an upper region opposed from the lower region, wherein a respective support element of the plurality of support elements is supported by the upper region of the at least one sidewall of the base element.

8. The apparatus according to claim 6, wherein the sidewall of the base element has a lower region attached to the bottom of the base element and an upper region opposed from the lower region, wherein a respective spacer element of the plurality of spacer elements is supported by the upper region of the at least one sidewall of the base element.

9. The apparatus according to claim 6, wherein each of the support elements of the plurality of support elements has a respective plurality of apertures.

10. The apparatus according to claim 6, wherein the support elements and the spacer elements are stackable and form a plurality of stacked configurations of support elements and spacer elements.

11. The apparatus according to claim 6, wherein at least some of the support elements have different cross sectional configurations.

12. The apparatus according to claim 6, wherein at least some of the spacer elements have different cross sectional configurations.

13. The apparatus according to claim 6, wherein at least some of the support elements have different cross sectional configurations, wherein at least some of the spacer elements have different cross sectional configurations, wherein the support elements and the spacer elements are stackable by matching corresponding cross sectional configurations of the support elements and the spacer elements, and wherein the support elements and the spacer elements form a plurality of stacked configurations of support elements and spacer elements.

14. The apparatus according to claim 6, wherein the support elements and the spacer elements are stackable and form a plurality of stacked configurations of support elements and spacer elements for a predetermined use, and form at least one storage configuration, the support elements and the spacer elements being nested at least partially within one another in the at least one storage configuration.

15. The apparatus according to claim 6, wherein each of the spacer elements has a predetermined height.

16. The apparatus according to claim 6, wherein each of the spacer elements of the plurality of spacer elements has a predetermined height, and wherein at least one spacer element of the plurality of spacer elements has a height different than a height of another spacer element of the plurality of spacer elements.

17. A cooking system, comprising:
a pot element having a bottom and at least one sidewall extending upwardly from the bottom;
a plurality of support elements located substantially above the bottom of the pot element, each of the support elements having a plurality of apertures; and
a plurality of spacer elements located substantially above the bottom of the pot element;
wherein at least one respective support element of the plurality of support elements supports at least one food item, and wherein the pot element contains a means for cooking the food item.

18. The cooking system according to claim 17, wherein the sidewall of the pot element has a lower region attached to the bottom of the pot element and an upper region opposed from the lower region, wherein a respective support element of the plurality of support elements is supported by the upper region of the at least one sidewall of the pot element.

19. The cooking system according to claim 17, wherein the sidewall of the pot element has a lower region attached to the bottom of the pot element and an upper region opposed from the lower region, wherein a respective spacer element of the plurality of spacer elements is supported by the upper region of the at least one sidewall of the pot element.

20. The cooking system according to claim 17, wherein the support elements and the spacer elements are stackable and form a plurality of stacked configurations of support elements and spacer elements.

21. The cooking system according to claim 17, wherein the cooking system further comprises a cover that is supported by an upper most spacer element of the plurality of spacer elements.

22. The cooking system according to claim 17, wherein at least some of the support elements have different cross sectional configurations.

23. The cooking system according to claim 17, wherein at least some of the spacer elements have different cross sectional configurations.

24. The cooking system according to claim 17, wherein at least some of the support elements have different cross sectional configurations, wherein at least some of the spacer elements have different cross sectional configurations, wherein the support elements and the spacer elements are stackable by matching corresponding cross sectional configurations of the support elements and the spacer elements, and wherein the support elements and the spacer elements form at least one stacked configuration of support elements and spacer elements.

25. The cooking system according to claim 17, wherein the support elements and the spacer elements are stackable and form a plurality of stacked configurations of support elements and spacer elements for a predetermined use, and form at least one storage configuration, the support elements and the spacer elements being nested at least partially within one another in the at least one storage configuration.

26. The cooking system according to claim 17, wherein each of the spacer elements has a predetermined height.

27. The cooking system according to claim 17, wherein each of the spacer elements of the plurality of spacer elements has a predetermined height, and wherein at least one spacer element of the plurality of spacer elements has a height different than a height of another spacer element of the plurality of spacer elements.

28. The cooking system according to claim 17, wherein a respective support element of the plurality of support elements and a respective spacer element of the plurality of spacer elements form a colander.

29. The cooking system according to claim 17, wherein each of the support elements has at least one handle.

30. The cooking system according to claim 17, wherein each of the spacer elements has at least one handle.

31. A stackable and configurable colander apparatus for cooking food items, comprising:
a pot having a bottom and at least one sidewall extending upwardly from the bottom;
a plurality of food supports located substantially above the bottom of the pot, each of the food supports having a plurality of apertures; and
a plurality of spacer walls located substantially above the bottom of the pot; and
a respective food support of the plurality of food supports and a respective spacer wall of the plurality of spacer walls forming a respective colander, and the food supports and the spacer walls being stackable and forming a plurality of stacked configurations of food supports and spacer walls;
wherein the respective colander holds at least one food item for cooking, and
wherein the pot element contains a means for cooking the food item.

32. The colander apparatus according to claim 31, wherein the colander apparatus further comprises a cover that is supported by an upper most spacer element of the plurality of spacer elements.

33. The colander apparatus according to claim 31, wherein at least some of the food supports have different cross sectional configurations.

34. The colander apparatus according to claim 31, wherein at least some of the spacer walls have different cross sectional configurations.

35. The colander apparatus according to claim 31, wherein at least some of the food supports have different cross sectional configurations, wherein at least some of the spacer walls have different cross sectional configurations, wherein the food supports and the spacer walls are stackable by matching corresponding cross sectional configurations of the food supports and the spacer walls, and wherein the food supports and the spacer walls form at least one stacked configuration of food supports and spacer walls.

36. The colander apparatus according to claim 31, wherein the food supports and the spacer walls are stackable and form a plurality of stacked configurations of food supports and spacer walls for a predetermined use, and form at least one storage configuration, the food supports and the spacer walls being nested at least partially within one another in the at least one storage configuration.

37. The colander apparatus according to claim 31, wherein each of the spacer walls of the plurality of spacer walls has a predetermined height.

38. The colander apparatus according to claim 31, wherein each of the spacer walls of the plurality of spacer walls has a predetermined height, and wherein at least one spacer wall of the plurality of spacer walls has a height different than a height of another spacer wall of the plurality of spacer walls.

39. A heating system for heating at least one item, comprising:
means for containing a medium for transferring heat to items;
means for supporting the items, the means for supporting located substantially above the means for containing, the means for supporting the items having a plurality of apertures; and
means for spacing located substantially above the means for containing and adjacent the means for supporting items.

40. The heating system according to claim 39, wherein the means for supporting and the means for spacing are stackable and form a plurality of stacked configurations of means for supporting and means for spacing.

41. The heating system according to claim 39, wherein the means for supporting and the means for spacing are stackable and form a plurality of stacked configurations of means for supporting and the means for spacing for a predetermined use, and form at least one storage configuration, the means for supporting and the means for spacing being nested at least partially within one another in the at least one storage configuration.

42. The heating system according to claim 39, wherein the heating system has a plurality of means for spacing, and wherein each of the means for spacing has a predetermined height.

43. The heating system according to claim 39, wherein the heating system has a plurality of means for spacing, and wherein each of the means for spacing has a predetermined height, and wherein at least one means for spacing of the plurality of means for spacing has a height different than a height of another means for spacing of the plurality of the plurality of means for spacing.

44. A cooking system, comprising:
a pot element having a top portion, the top portion having a plurality of apertures therein;
a plurality of colander systems, a respective colander system being located above a respective aperture of the plurality of apertures in the top portion;
each of the colander systems having a plurality of support elements located substantially above the bottom of the pot element, each of the support elements having a plurality of apertures, and a plurality of spacer elements located substantially above the bottom of the pot element.

45. The cooking system according to claim 44, wherein at least some of the support elements have different cross sectional configurations.

46. The cooking system according to claim 44, wherein at least some of the spacer elements have different cross sectional configurations.

47. The cooking system according to claim 44, wherein at least some of the support elements have different cross sectional configurations, wherein at least some of the spacer elements have different cross sectional configurations, wherein the support elements and the spacer elements are stackable by matching corresponding cross sectional configurations of the support elements and the spacer elements, and wherein the support elements and the spacer elements form at least one stacked configuration of support elements and spacer elements.

48. The cooking system according to claim 44, wherein the support elements and the spacer elements are stackable and form a plurality of stacked configurations of support elements and spacer elements for a predetermined use, and form at least one storage configuration, the support elements and the spacer elements being nested at least partially within one another in the at least one storage configuration.

49. The cooking system according to claim 44, wherein each of the spacer elements has a predetermined height.

50. The cooking system according to claim 44, wherein each of the spacer elements of the plurality of spacer elements has a predetermined height, and wherein at least one spacer element of the plurality of spacer elements has a height different than a height of another spacer element of the plurality of spacer elements.

51. An apparatus, comprising:
a base element;
a cover element;
a support element; and
at least one spacer element locatable between at least one of the base element and the support element, and the support element and the cover element.

52. The apparatus according to claim 51, wherein the sidewall of the base element has a lower region attached to a bottom of the base element and an upper region opposed from the lower region, wherein the support element is supported by the upper region of the base element, and wherein the spacer element is located above the support element.

53. The apparatus according to claim 51, wherein the sidewall of the base element has a lower region attached to a bottom of the base element and an upper region opposed from the lower region, wherein the spacer element is supported by the upper region of base element, and wherein the support element is located above the spacer element.

54. The apparatus according to claim 51, wherein the support element has a plurality of apertures.
